(19) United States
(12) Patent Application Publication
(10) Pub. No.: US 2026/0004226 A1
(43) Pub. Date: Jan. 1, 2026

(54) SYSTEMS, METHODS, AND DEVICES FOR OPTIMIZED LOAD SELECTION FOR SEMI-TRAILER TRUCKS

(71) Applicant: Knowledge Relay, Inc., Cypress, CA (US)

(72) Inventors: Steven K. Mauss, Cypress, CA (US); Ronald Anthony Caetano, Riverdale, CA (US); Jeff Muus, La Mirada, CA (US); John L. Rosenlof, Long Beach, CA (US)

(21) Appl. No.: 19/255,803

(22) Filed: Jun. 30, 2025

Related U.S. Application Data
(60) Provisional application No. 63/665,739, filed on Jun. 28, 2024.

(51) Int. Cl. G06Q 10/083; G06Q 10/0631

(52) U.S. Cl. CPC G06Q 10/083; G06Q 10/06312

(57) ABSTRACT

A system for optimized load selection for semi-trailer trucks. A processor or a server of the system is configured to receive, via a user device in communication with the server, user input data indicating a starting location, a search radius, and a search candidate threshold, search a load board for one or more load transport jobs based on the starting location and the search radius indicated in the received user input data, and select a quantity of the one or more load transport jobs based on the search candidate threshold indicated in the received user input data. The processor or the server is configured to assign each of the selected one or more load transport jobs to one or more trip profiles, each having a total revenue, and sort the one or more trip profiles based on the total revenue of each of the one or more trip profiles.

### CROSS REFERENCE TO RELATED APPLICATIONS

This application claims the benefit and priority of U.S. Provisional Application Ser. No. 63/665,739, entitled “Systems, Methods, and Devices for Optimizing Load Selection for Semi-Trailer Trucks,” filed on Jun. 28, 2024, the content of which is hereby incorporated by reference in its entirety herein.

### BACKGROUND

### 1. Field

The present disclosure relates to systems, methods, and devices for optimizing load selection for semi-trailer trucks, and more particularly, to systems, methods, and devices for maximizing potential revenues for semi-trailer trucks by building portfolios of the most profitable loads based on available time.

### 2. Description of the Related Art

Operating a trucking business for the transportation of goods has become very demanding with so many retailers trying to compete with companies such as Amazon®. While many large companies have a fleet of trucks, many small businesses are also trying to compete and gain ground in this competitive business. Many small businesses have one or more semi-trailer trucks used to transport freight. Sometimes these semi-trailer trucks are owner-operated, i.e., the owner of the semi-trailer truck is also the driver or operator of the truck. Owner-operators generally like to control and manage their businesses by, for example, (1) making sure the semi-trailer truck is in good condition, and operating efficiently, (2) ensuring staff members are working and delivering goods, (3) making sure they are receiving positive customer feedback, reviews and payments for services, and (4) preventing load fraud, which is at an all-time high.

While this might appear to be very attractive and beneficial to the owner-operator, several challenges and drawbacks exist with this type of structure such as the difficulty in scheduling loads. Owner-operators try to make the scheduling of loads a priority but other parts of the business generally take priority. Also, owner-operators are often unable to accurately and efficiently select and/or schedule loads to maximize revenues. Selecting loads 1-at-a-time, when performed by owner-operators, is very complex and difficult because some loads have already been scheduled when other loads may need to take priority. This makes the logistics for owner-operators very complex and difficult and sometimes unachievable. In addition, owner-operators are fixed on scheduling loads based on a revenue per mile model, which does not always maximize revenues to the owner.

Accordingly, it is desirable to provide systems, methods, and devices for maximizing potential revenues for semi-trailer trucks by building portfolios of the most profitable loads based on available time.

### SUMMARY

A system for optimized load selection for semi-trailer trucks. A processor or a server of the system is configured to receive, via a user device in communication with the server, user input data indicating a starting location, a search radius, and a search candidate threshold, search a load board for one or more load transport jobs based on the starting location and the search radius indicated in the received user input data, and select a quantity of the one or more load transport jobs based on the search candidate threshold indicated in the received user input data. The processor or the server is configured to assign each of the selected one or more load transport jobs to one or more trip profiles, each having a total revenue, and sort the one or more trip profiles based on the total revenue of each of the one or more trip profiles.

### BRIEF DESCRIPTION OF THE DRAWINGS

FIG. 1 is a block diagram showing the components of an exemplary system for optimized load selection for semi-trailer trucks according to an aspect of the present invention.

FIGS. 2A and 2B is a flowchart showing a process executed by the exemplary system of FIG. 1 for optimizing load selection for semi-trailer trucks according to an aspect of the present invention.

FIGS. 3A and 3B is a flowchart showing a process executed by the exemplary system of FIG. 1 for optimizing load selection for semi-trailer trucks according to an aspect of the present invention.

Other systems, methods, features, and advantages of the present invention will be or will become apparent to one of ordinary skill in the art upon examination of the following figure and detailed description.

### DETAILED DESCRIPTION

Systems, methods, and devices are described herein that are used for optimizing load selection for semi-trailer trucks. The systems, methods, and devices are used to maximize potential revenues for semi-trailer trucks by analyzing industry data to build portfolios with the most profitable loads or identify all available loads and select the most profitable loads based on available time.

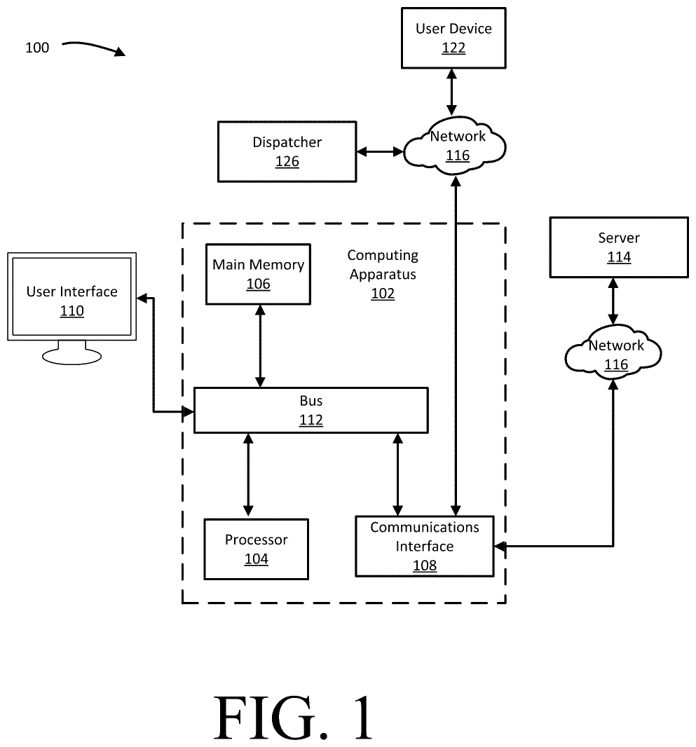

FIG. 1 is a block diagram showing the components of an exemplary system 100 for optimized load selection for semi-trailer trucks according to an aspect of the present invention. The system 100 (e.g., a computing system) may include a computing apparatus 102. The computing apparatus 102 may include one or more processors 104, a memory 106, and/or a bus 112 and/or other mechanisms for communicating between the one or more processors 104. The system 100 may be a cloud computing system including processors, servers, storage, databases, networking, software, analytics, and/or intelligence accessed or performed over or using the Internet (“the cloud”). The one or more processors 104 may be implemented as a single processor or as multiple processors. The one or more processors 104 may execute instructions stored in the memory 106 to implement processes of the system 100. The one or more processors 104 may execute or implement artificial intelligence (AI) algorithms, machine learning (ML) algorithms, or processes as described herein to analyze industry data, and build portfolios that predict or identify all available loads and select the most profitable loads based on available time.

The memory 106 may be coupled to the one or more processors 104. The memory 106 may include one or more of a Random Access Memory (RAM) or other volatile or non-volatile memory. The memory 106 may be a non-transitory memory or a data storage device, such as a hard disk drive, a solid-state disk drive, a hybrid disk drive, or other appropriate data storage, and may further store machine-readable instructions, which may be loaded and executed by the one or more processors 104.

The memory 106 may include one or more of random-access memory (“RAM”), static memory, cache, flash memory and any other suitable type of storage device or computer readable storage medium, which is used for storing instructions to be executed by the one or more processors 104. The storage device or the computer readable storage medium may be a read only memory (“ROM”), flash memory, and/or memory card, that may be coupled to the bus 112 or other communication mechanism. The storage device may be a mass storage device, such as a magnetic disk, optical disk, and/or flash disk that may be directly or indirectly, temporarily, or semi-permanently coupled to the bus 112 or other communication mechanism and be electrically coupled to some or all the other components within the system 100 including the memory 106, a user interface 110, and/or a communications interface 108 via the bus 112.

The term “computer-readable medium” is used to define any medium that can store and provide instructions and other data to a processor, particularly where the instructions are to be executed by a processor and/or other peripheral of the processing system. Such medium can include non-volatile storage, volatile storage, and transmission media. Non-volatile storage may be embodied on media such as optical or magnetic disks. Storage may be provided locally and in physical proximity to a processor or remotely, typically by use of network connection. Non-volatile storage may be removable from the computing system, as in storage or memory cards or sticks that can be easily connected or disconnected from a computer using a standard interface.

The system 100 may include the user interface 110. The user interface 110 may include an input/output device. The input/output device may receive user input (or user input data) via a user interface element, a hand-held controller that provides tactile/proprioceptive feedback, a button, a dial, a microphone, a keyboard, and/or a touch screen, and/or may output data via a display, a speaker, an audio and/or visual indicator, and/or a refreshable braille display. The display may be a computer display, a tablet display, a mobile phone display, an augmented reality display, or a virtual reality headset.

The system 100 may have a network 116 connected to a server 114. The network 116 may be a cloud network, a local area network (LAN), a wide area network (WAN), a cellular network, the Internet, or combination thereof, that connects, couples and/or otherwise communicates between the various components of the system 100 with the server 114. The server 114 may be a remote computing device or system that includes a memory, a processor, and/or a network access device coupled together via a bus. The server 114 may be a computer in a network that is used to provide services, such as accessing files or sharing peripherals, to other computers in the network.

The server 114 may include a database. A database is any collection of pieces of information that is organized for search and retrieval, such as by a computer, and the database may be organized in tables, schemas, queries, reports, or any other data structures. A database may use any number of database management systems. The information may include real-time information, periodically updated information, or user-inputted information. The server 114 and/or the database may store a load board including available load transport jobs (or trucking loads) and information about the available load transport jobs, such as a starting location of the loads, an ending location of the loads, an amount of hours the available load transport jobs will take, a distance of the available load transport jobs, a payment amount or revenue of the available load transport jobs, and a payment amount per minute or hour (e.g., total payment amount/amount of hours the load transport job will take) of the available load transport jobs.

The system 100 may include the communications interface 108, such as a network access device. The communications interface 108 may include a communication port or channel, such as one or more of a Dedicated Short-Range Communication (DSRC) unit, a Wi-Fi unit, a Bluetooth® unit, a radio frequency identification (RFID) tag or reader, or a cellular network unit for accessing a cellular network (such as 3G, 4G or 5G). The communications interface 108 may transmit data to and receive data from the different components.

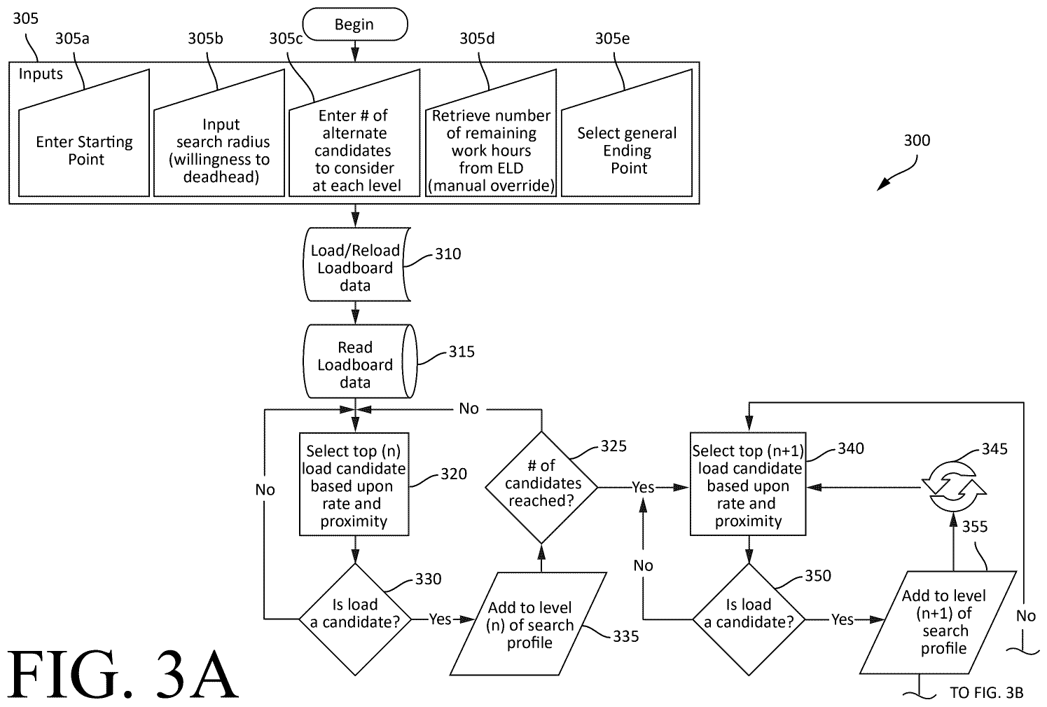

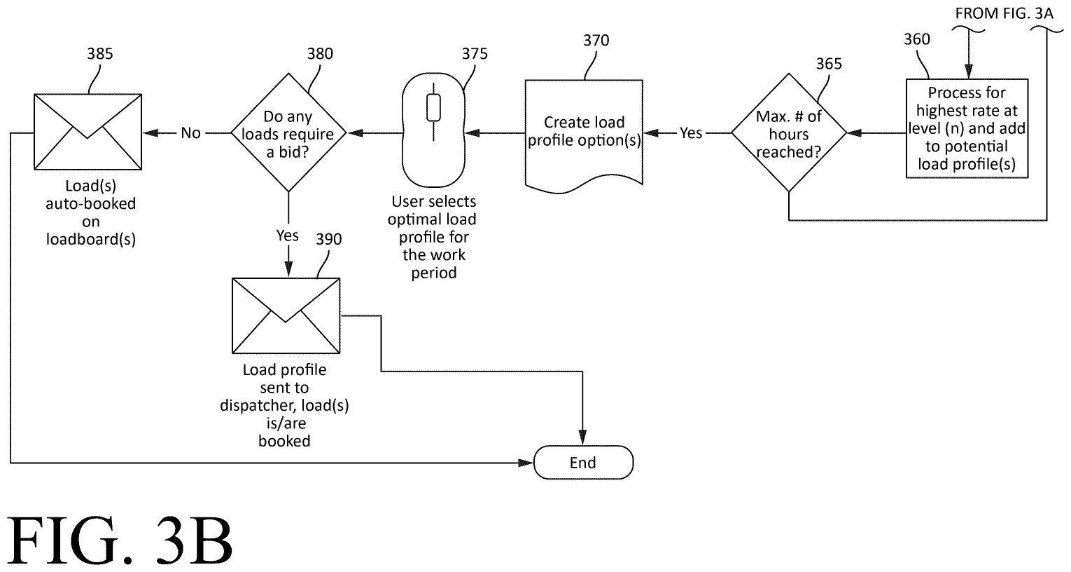

The system 100 may include a user device 122. The user device 122 may be a mobile device, a phone, a tablet, a laptop, a computer, or a vehicle. The user device 122 may include a memory, a processor, a display screen, and/or a network access device coupled together via a bus. The user device 122 may include a user interface having an input/output device. The input/output device of the user device 122 may receive user input (or user input data) via a user interface element, a hand-held controller that provides tactile/proprioceptive feedback, a button, a dial, a microphone, a keyboard, and/or a touch screen, and/or may output data via a display, a speaker, an audio and/or visual indicator, and/or a refreshable braille display. The display may be a computer display, a tablet display, a mobile phone display, an augmented reality display, or a virtual reality headset. The user input data 305 may include a starting location 305a, a search radius 305b, a search candidate threshold 305c (e.g., enter the number of alternate candidates to consider at each level), number of remaining work hours 305d (e.g., from an electronic logging device (ELD)), and/or an ending location 305e (see also FIG. 3). The ELD may be a software application and/or hardware executed or implemented on the user device 122. The user device 122 may transmit the user input data 305 to the computing apparatus 102.

The system 100 may include a dispatcher 126. The dispatcher 126 may be and/or include a server that may be a remote computing device or system that includes a memory, a processor and/or a network access device coupled together via a bus. The server of the dispatcher 126 may be a computer in a network that is used to provide services, such as accessing files or sharing peripherals, to other computers in the network. The dispatcher 126 may coordinate and/or manage scheduling, bookings, availability, locations, rates, and/or terms of load transport jobs (or trucking loads).

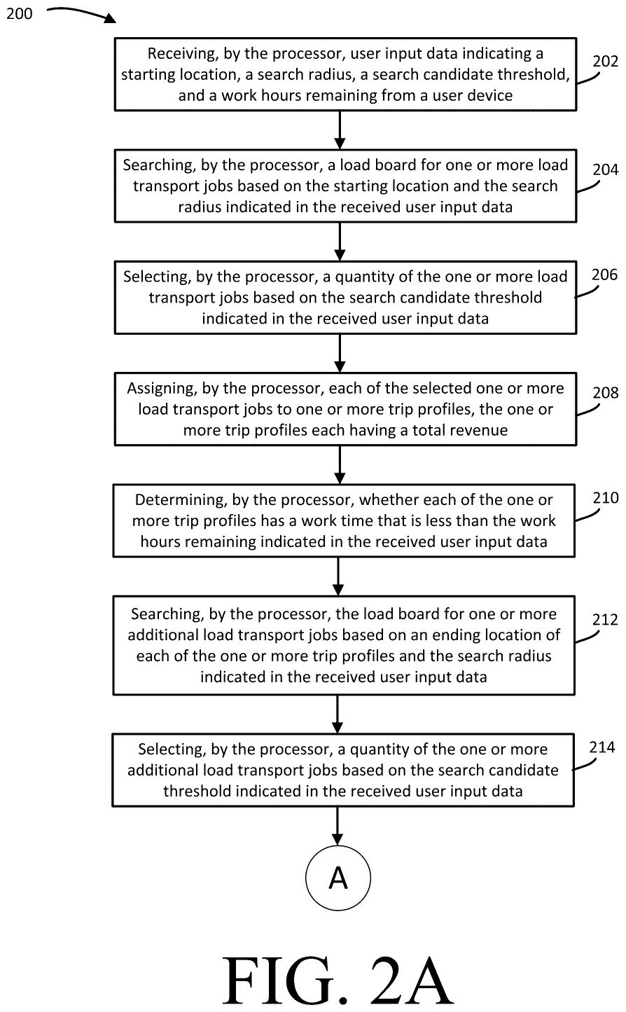

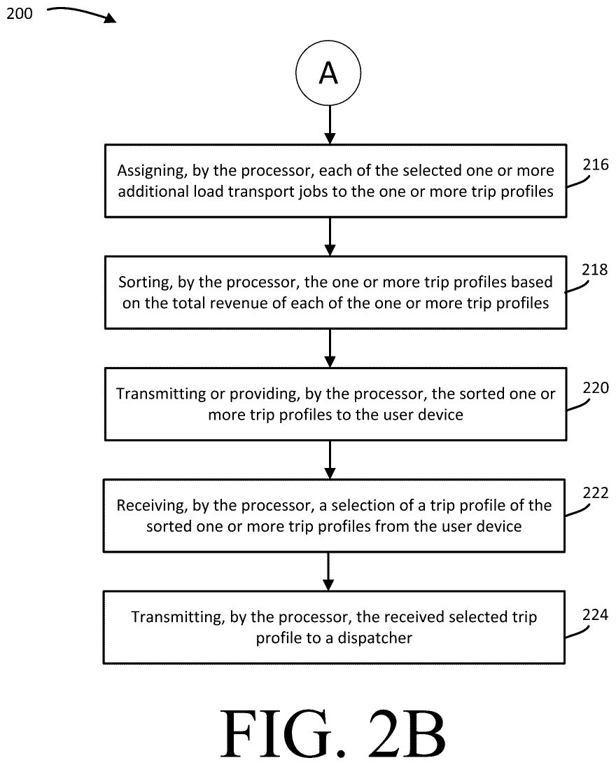

FIGS. 2A and 2B is a flowchart showing a process 200 executed by the exemplary system 100 of FIG. 1 for optimizing load selection for semi-trailer trucks according to an aspect of the present invention. FIGS. 3A and 3B is a flowchart showing a process 300 executed by the exemplary system of FIG. 1 for optimizing load selection for semi-trailer trucks according to an aspect of the present invention. The process 200 and the process 300 are related with some overlap and some differences so both processes will be described herein together. Features and aspects from process 200 and process 300 can be combined, interchanged, added, and removed between the two processes while still maintaining the spirit and scope of the present invention. Referring now to FIGS. 1, 2A, 2B, 3A, and 3B, the process 200 or 300 performed by the exemplary system 100 (e.g., by the processor 104) is illustrated, in accordance with various aspects of the present invention.

The process 200 or 300 for optimizing load selection for semi-trailer trucks can include receiving user input data 305 from the user device 122 (step 202, block 305). The driver or operator of the semi-trailer truck, using his/her user device 122, inputs, via a graphical user interface from a software application on the user device 122 and/or received from the processor 104 or the server 114, user input data 305 about his/her desired starting location 305a, a search radius 305b indicating an amount of miles or kilometers radius he/she would like to travel from the starting location to a pickup location for a pickup of a load, a number of alternative candidates 305c to consider at each level (e.g., a search candidate threshold), a number of remaining work hours 315d (e.g., the driver has only 4.5 remaining work hours that day), and/or his/her desired ending location 305e.

The driver or operator can input his/her current starting location or desired starting location. The starting location 305a is the location where the semi-trailer truck will start from. If the driver is physically located in Fresno, California and wants to start driving from there, then the driver would enter Fresno, California as the starting location 305a. If the driver is physically located in Fresno, California but wants to start driving from Los Angeles, California, the driver would enter Los Angeles, California as the starting location 305a, and would have to drive there to start.

The search criteria or radius 305b is input by the driver to indicate the distance from the starting location 305a that the driver is willing to drive to start the job. As an example, if the starting location 305a is Los Angeles, California and the search radius 305b is 150 miles, the list of available jobs would include jobs in San Diego, California, which is about 130 miles away, however, would not include jobs in Las Vegas, Nevada, which is about 240 miles away.

The number of alternative candidates 305c to consider at each level can be, for example, consider 5 jobs at base revenue level, 3 jobs at moderate revenue level, and 1 job at high revenue level. The number of alternative candidates 305c can also be a search candidate threshold. For example, the search candidate threshold can be a limit on the total number of load transport jobs the driver would like to view and/or perform per day or per trip, e.g., a search candidate threshold can be 5.

The number of remaining work hours 315d the driver has or desires can be input or automatically retrieved from ELD. The driver may want to work a total of 10 hours per day, from 8 am to 6 pm, but at 10 am, the number of remaining work hours would be 8 hours. The driver might want to input the desired ending location 305e to be near his/her home or place where the semi-trailer truck needs to be stored for the night. The process 200 or 300 would schedule the last transport job of the work hours to be closest to the desired ending location 305e.

The process 200 or 300 can further include the dispatcher 126 loading or reloading load board data into the memory 106 (block 310). The dispatcher 126 can be a human or an AI, ML or automated system. The load board data includes a listing of all load transport jobs, and for each job, a location of the job, a total number of hours to complete the job, a difficulty rating (1-10) of the job, revenue per hour for the job, total revenue for the job, etc.

The processor 104 receives the user input data 305, and the dispatcher 126, accessing or using the processor 104 and/or the server 114, reviews the load board data (block 315). The processor 104 or the dispatcher 126 searches or initiates an automatic search of the load board data for load transport jobs that meet the criteria and that the driver should do based on at least one of the received user input data 305 (step 204, block 315). For example, the starting location 305a and the search criteria 305b are used to determine and provide a list of one or more load transport jobs meeting the starting location 305a and/or the search criteria 305b to the user device 122 of the driver or operator for review and/or acceptance (step 204). The list is set up such that the highest total revenue load transport jobs are listed first (block 320). As an example, the processor 104 searches the load board data for a list of the available load transport jobs, which were previously input by the dispatcher 126 and stored in the memory 106. The list of load transport jobs may be limited by the search candidate threshold 305c.

Blocks 320-370 show an exemplary process for creating a list of the one or more load transport jobs with the highest total revenue. At block 320, the processor 104 or the server 114 selects the top(n) load candidates based on the highest total revenue and the proximity to the starting location. At block 330, the processor 104 or the server 114 determines if there are any load candidates. If no, the processor 104 or the server 114 broadens or expands the search to top(n+1) load candidates. If yes, the processor 104 or the server 114 adds to level(n) of the search profile (block 335). If the processor 104 or the server 114 determines that the total number of candidates has been reached then the top(n+1) load candidates are selected based on the highest total revenue and the proximity to the starting location (block 340). The processor 104 or the server 114 then determines whether the number of hours has been reached (block 365). If no, the processor 104 or the server 114 broadens or expands the search to include additional load candidates. If yes, the processor 104 or the server 114 creates the list of the one or more load transport jobs with the highest total revenues (block 370).

The process 200 or 300 can display on the display screen of the user device 122, the list of the one or more load transport jobs with the highest total revenue for that load transport job. The search can return or select one or more loads depending on the available load transport jobs meeting the search criteria (step 206). The search is filtered and listed based on the highest total revenue of the available load transport jobs input by the dispatcher 126 and stored in the memory 106. In some aspects, the search and selection are performed by the AI, ML or automated system (i.e., the processor 104 and/or the server 114).

The processor 104 and/or the server 114 can select a quantity of the one or more load transport jobs to display on the user device 122 based on the search candidate threshold indicated in the received user input data (step 206, block 375). The driver or operator or the processor 104 can accept or reject which load transport jobs he/she wishes to do based on the total revenues, the proximity, the estimated total time of the job, and/or the number of remaining work hours.

The process 200 or 300 can further include assigning each of the selected one or more load transport jobs to one or more trip profiles, the one or more trip profiles each having a total revenue (step 208). The one or more load transport jobs are listed based on highest total revenue being listed first. Each trip profile includes all the load transport jobs for a particular trip including a total revenue for all the load transport jobs for that particular trip.

In various aspects, the process 200 or 300 can further include determining, by the processor 104, whether each of the one or more trip profiles has a work time that is less than the work hours remaining indicated in the received user input data (step 210). This may mean that the driver has additional time to schedule one or more additional load transport jobs for that particular trip profile. The work time may be a predetermined or determined amount of hours that the load transport job(s) assigned to a respective trip profile will require to complete. This allows the driver to see if additional load transport jobs can be scheduled since there are additional hours of work that can be filled for the driver.

In various aspects, the process 200 or 300 can further include searching the load board for one or more additional load transport jobs based on an ending location of each of the one or more trip profiles and the search radius indicated in the received user input data (step 212). This may allow for additional load transport jobs to be added to fill up the work hours remaining. If the user input data 305 includes an ending location 305e, the last scheduled job will end up there or close to there with enough time to get to that location in the allotted time period set during the search.

In various aspects, the process 200 or 300 can further include selecting a quantity of the one or more additional load transport jobs based on the search candidate threshold indicated in the received user input data (step 214). This is an input during the search that would limit or expand the number of options that are returned. This would increase or decrease processing time. For example, if the driver wants 5 options at each point, then the process 200 or 300 will provide 5 options at each stop. The driver can set it to 1, then the process 200 or 300 will only give the driver the best job at each stop. This can add one or more load transport jobs with the highest total revenue.

In various aspects, the process 200 or 300 can further include assigning each of the selected one or more additional load transport jobs to the one or more trip profiles (step 216). The process 200 or 300 can give the driver more options if there are more stops available based on the time remaining after the previous job was added or completed.

The process 200 or 300 can further include sorting the one or more trip profiles based on the total revenue of each of the one or more trip profiles (step 218). For example, the trip profiles with the highest total revenue will be listed first. The process 200 or 300 can further include transmitting or providing the sorted one or more trip profiles to the user device 122 (step 220). The driver or the operator can view the one or more trip profiles on their user device 122.

In various aspects, the process 200 or 300 can further include receiving a selection of a trip profile of the sorted one or more trip profiles from the user device 122 (step 222). The driver or the operator can view the different trip profiles and can determine which one (or more) to select and/or which one (or more) to reject. In various aspects, the process 200 or 300 can further include transmitting the selected trip profile(s) from the user device 122 to the dispatcher (step 224). Once received, the dispatcher 126 determines or provides an optimal route to the user device 122 (i.e., to the driver).

Exemplary aspects and embodiments of the systems/methods/devices have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for optimized load selection for semi-trailer trucks, the system comprising:
a processor or a server configured to:
receive, via a user device in communication with the server, user input data indicating a starting location, a search radius, and a search candidate threshold;
search a load board for one or more load transport jobs based on the starting location and the search radius indicated in the received user input data;
select a quantity of the one or more load transport jobs based on the search candidate threshold indicated in the received user input data;
assign each of the selected one or more load transport jobs to one or more trip profiles, the one or more trip profiles each having a total revenue;
sort the one or more trip profiles based on the total revenue of each of the one or more trip profiles; and
transmit or provide the sorted one or more trip profiles to the user device.

2. The system of claim 1, wherein:
the user input data further indicates work hours remaining; and
the server is further configured to:
determine a quantity of available hours for each of the one or more trip profiles based on the work hours remaining indicated in the received user input data,
search the load board for one or more additional load transport jobs based on the determined quantity of available hours for each of the one or more trip profiles, an ending location of each of the one or more trip profiles, and the search radius indicated in the received user input data,
select a quantity of the one or more additional load transport jobs based on the search candidate threshold indicated in the received user input data, and
assign each of the selected one or more additional load transport jobs to the one or more trip profiles.

3. The system of claim 1, wherein the load board is stored on a database or another server in communication with the server.

4. The system of claim 1, wherein:
the user device is a mobile device, a phone, a laptop, a tablet, a computer, or a vehicle; and
the server is further configured to:
receive a selection of a trip profile of the sorted one or more trip profiles from the user device.

5. The system of claim 4, wherein the server is further configured to:
transmit the received selected trip profile to a dispatcher.

6. A method for optimized load selection for semi-trailer trucks, the method comprising:
receiving user input data indicating a starting location, a search radius, a search candidate threshold, and work hours remaining from a user device;
searching a load board for one or more load transport jobs based on the starting location and the search radius indicated in the received user input data;
selecting a quantity of the one or more load transport jobs based on the search candidate threshold indicated in the received user input data;
assigning each of the selected one or more load transport jobs to one or more trip profiles, the one or more trip profiles each having a total revenue;
sorting the one or more trip profiles based on the total revenue of each of the one or more trip profiles; and
transmitting or providing the sorted one or more trip profiles to the user device.

7. The method of claim 6, further comprising:
determining whether each of the one or more trip profiles has a work time that is less than the work hours remaining indicated in the received user input data;
searching the load board for one or more additional load transport jobs based on an ending location of each of the one or more trip profiles and the search radius indicated in the received user input data;
selecting a quantity of the one or more additional load transport jobs based on the search candidate threshold indicated in the received user input data; and
assigning each of the selected one or more additional load transport jobs to the one or more trip profiles.

8. The method of claim 6, wherein the load board is stored on a database or a server.

9. The method of claim 6, further comprising:
receiving a selection of a trip profile of the sorted one or more trip profiles from the user device; and
wherein the user device is a mobile device, a phone, a laptop, a tablet, a computer, or a vehicle.

10. The method of claim 9, further comprising:
transmitting the received selected trip profile to a dispatcher.

11. A system for optimized load selection for semi-trailer trucks, the system comprising:
a software application configured to:
receive, via a user device in communication with the server, user input data indicating a starting location, a search radius, and a search candidate threshold;
search a load board for one or more load transport jobs based on the starting location and the search radius indicated in the received user input data;
select a quantity of the one or more load transport jobs based on the search candidate threshold indicated in the received user input data;
assign each of the selected one or more load transport jobs to one or more trip profiles, the one or more trip profiles each having a total revenue;
sort the one or more trip profiles based on the total revenue of each of the one or more trip profiles; and
transmit or provide the sorted one or more trip profiles to the user device.

12. The system of claim 11, wherein:
the user input data further indicates work hours remaining; and
the software application is further configured to:
determine a quantity of available hours for each of the one or more trip profiles based on the work hours remaining indicated in the received user input data,
search the load board for one or more additional load transport jobs based on the determined quantity of available hours for each of the one or more trip profiles, an ending location of each of the one or more trip profiles, and the search radius indicated in the received user input data,
select a quantity of the one or more additional load transport jobs based on the search candidate threshold indicated in the received user input data, and
assign each of the selected one or more additional load transport jobs to the one or more trip profiles.

13. The system of claim 11, wherein the load board is stored on a database.

14. The system of claim 11, wherein:
the user device is a mobile device, a phone, a laptop, a tablet, a computer, or a vehicle; and
the software application is further configured to:
receive a selection of a trip profile of the sorted one or more trip profiles from the user device.

15. The system of claim 14, wherein the software application is further configured to:
transmit the received selected trip profile to a dispatcher.
